(19) United States
(12) Patent Application Publication
(10) Pub. No.: US 2018/0358893 A1
(43) Pub. Date: Dec. 13, 2018

(54) POWER CONVERSION DEVICE AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Taku YAMABE, Fuji Shizuoka (JP); Toyoyasu KUSAKA, Izu Shizuoka (JP)

(21) Appl. No.: 15/891,266

(22) Filed: Feb. 7, 2018

(30) Foreign Application Priority Data
Jun. 9, 2017 (JP) 2017-114138

(51) Int. Cl. H02M 7/06; H02M 1/36; H02M 7/5395

(52) U.S. Cl. CPC H02M 1/36; G03G 15/5004; G03G 15/80; H02M 7/5395

(57) ABSTRACT

A power conversion device includes a power supply, transformer comprising a primary winding, a first secondary winding and a second secondary winding, a converter connected to the primary winding, a control circuit connected to the converter, and a startup circuit. The startup circuit comprises a first switching element configured to switch between an ON state and an OFF state, a constant current circuit configured to supply power of a predetermined voltage to the control circuit when the first switching element is in the ON state, and an isolator comprising a first current path connected to a control terminal of the first switching element, and a second current path isolated from the first current path and including a selectable connection to ground. The first switching element is switched to the ON state as a result of current flowing through the first current path when current flows in the second current path.

### CROSS-REFERENCE TO RELATED APPLICATION

This application is based upon and claims the benefit of priority from Japanese Patent Application No. 2017-114138, filed Jun. 9,2017, the entire contents of which are incorporated herein by reference.

### FIELD

Embodiments described herein relate generally to a power conversion device and an image forming apparatus.

### BACKGROUND

Generally, a power conversion device which includes a converter, an electric transformer, and a control circuit is known. The converter performs conversion of supplied power by switching. The electric transformer transforms power supplied from the converter and outputs the transformed power. The control circuit controls switching of the converter.

In the power conversion device, a DC voltage is obtained in a manner that an AC voltage obtained from an AC power supply is pulsed by a full-wave rectifying circuit, and a positive voltage obtained by this pulsing is smoothed by a capacitor. In the power conversion device, the control circuit controls switching of the converter, and thus the DC voltage is converted into a high-frequency pulse. In the electric transformer, a magnetic field is generated in a winding on the primary side (primary winding) by the high-frequency pulse which is converted by the converter, a winding on the secondary side (secondary winding) is excited, and thus power is supplied to a load connected to the secondary side.

The control circuit operates by the DC voltage which is transformed by the electric transformer and is smoothed. However, in order to obtain a voltage from the electric transformer, it is necessary that the control circuit operates the converter. Thus, a power conversion device which further includes an startup circuit is provided. The startup circuit supplies power to the control circuit, so as to start up the control circuit.

The startup circuit supplies a constant current to the control circuit via a switching element and a resistor, by using the DC voltage obtained from the AC power supply. In such a startup circuit, it is necessary that the gate terminal of the switching element is normally maintained at GND level, in order to cause the switching element to be in an OFF state. In such a configuration, there is a problem in that power is normally consumed in a circuit connected to the gate terminal of the switching element.

### DESCRIPTION OF THE DRAWINGS

FIG. 1 is a diagram illustrating an example of a configuration of an image forming apparatus according to an embodiment.

FIG. 2 is a diagram illustrating an example of a configuration of a power conversion device according to the embodiment.

FIG. 3 is a diagram illustrating an example of an operation of the power conversion device according to the embodiment.

FIG. 4 is a diagram illustrating another example of the configuration of the power conversion device according to the embodiment.

### DETAILED DESCRIPTION

Embodiments provide a power conversion device which is capable of reducing loss, and an image forming apparatus.

According to an embodiment, a power conversion device includes a power supply, a transformer comprising a primary winding, a first secondary winding and a second secondary winding, a converter connected to the primary winding of the transformer, a control circuit connected to the converter, and a startup circuit. The startup circuit comprises a first switching element configured to switch between an ON state wherein current may pass therethrough, and an OFF state wherein current is prevented from passing therethrough, a constant current circuit configured to supply power of a predetermined voltage to the control circuit when the first switching element is in the ON state, and an isolator comprising a first current path connected to a control terminal of the first switching element, and a second current path isolated from the first current path and including a selectable connection to ground. The first switching element is switched to the ON state as a result of current flowing through the first current path when current flows in the second current path.

Hereinafter, an embodiment will be described with reference to the drawings.

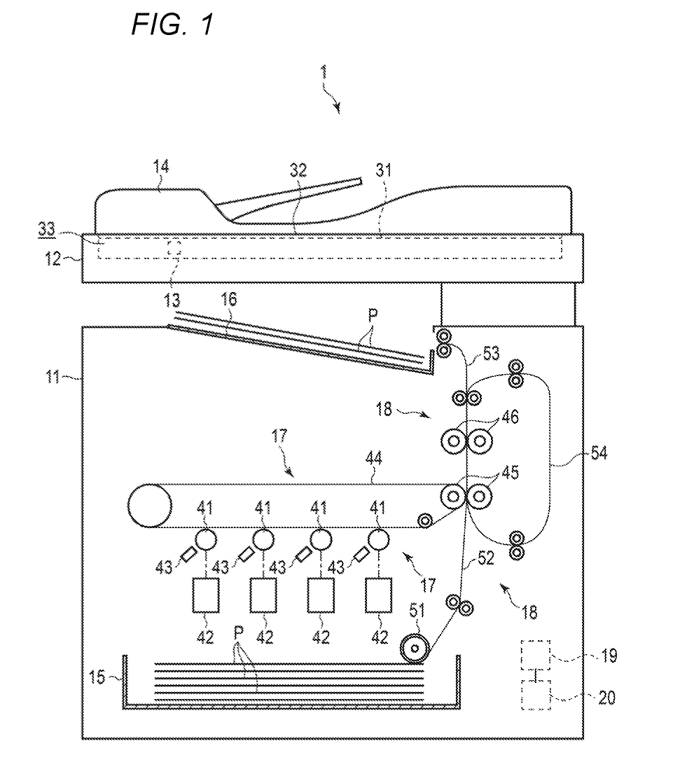

FIG. 1 is a diagram illustrating a configuration example of an image forming apparatus 1 according to an embodiment.

The image forming apparatus 1 is, for example, a multifunction printer (MFP) that performs various types of processing such as image forming, while transporting a recording medium such as a print medium therein. The image forming apparatus 1 charges a photoconductive drum and irradiates the photoconductive drum with light in accordance with image data (print data) for printing, so as to form a latent image (electrostatic latent image) on the photoconductive drum. The image forming apparatus 1 adheres a toner (developer) to the latent image formed on the photoconductive drum, and transfers the toner which adheres to the latent image onto a print medium, so as to form a toner image on the print medium. The image forming apparatus 1 nips the print medium on which the toner image is formed, by a fixing roller which is heated to a high temperature by a heater, so as to fix the formed toner image on the print medium.

The image forming apparatus 1 acquires an image on a print medium in a manner that imaging is performed by an image sensor using light reflected from an image on a medium, charge accumulated in the image sensor is read, and the read charge is converted into a digital signal.

The image forming apparatus 1 includes a housing 11, a document stand 12, a scanner unit 13, an automatic document feeder (ADF) 14, a paper feeding cassette 15, a paper discharge tray 16, an image forming unit 17, a transporting unit 18, a main controller 19, and a power conversion device 20.

The housing 11 is the main body for holding the document stand 12, the scanner unit 13, the ADF 14, the paper feeding cassette 15, the paper discharge tray 16, the image forming unit 17, the transporting unit 18, the main controller 19, and the power conversion device 20.

The document stand 12 is a part on which a print medium P, as an original document, is placed. The document stand 12 includes a glass plate 31 and a space 33. The print medium P as the original document is placed on the glass plate 31. The space 33 is positioned on a surface on an opposite side of a placement surface 32 of the glass plate 31, on which the print medium P as the original document is placed.

The scanner unit 13 acquires an image from the print medium P in accordance with a control of the main controller 19. The scanner unit 13 is disposed in the space 33 on the side of the document stand 12, which is an opposite side of the placement surface 32. The scanner unit 13 includes an image sensor, an optical element, and the like.

The image sensor is an imaging element in which pixels in which light is converted into an electric signal (image signal) are arranged in a line. The image sensor is configured, for example, of a charge coupled device (CCD), a complementary metal oxide semiconductor (CMOS), or other imaging elements.

The optical element forms an image in the pixels of the image sensor using light from a predetermined reading range. The reading range of the optical element is a line-like region on the placement surface 32 of the document stand 12. The optical element forms an image in the pixels of the image sensor by light which is reflected by the print medium P placed on the placement surface 32 of the document stand 12 and which transmits through the glass plate 31.

Illumination equipment irradiates the print medium P with light. The illumination equipment includes a light source and a light guide for irradiating the print medium P with light from the light source. The illumination equipment irradiates a region including the reading region of the optical element, with light emitted from the light source. The irradiation is performed by the light guide.

When the print medium P is placed on the placement surface 32 of the document stand 12, the scanner unit 13 is driven by a driving mechanism (not illustrated), in a sub-scanning direction which is perpendicular to an arrangement direction (main scanning direction) of the pixels in the image sensor and is parallel to the placement surface 32. The scanner unit 13 continuously acquires an image for each line by the image sensor, while being driven in the sub-scanning direction. Thus, the scanner unit 13 acquires image data (original document image data) of the entirety of the print medium P placed on the placement surface 32 of the document stand 12.

The ADF 14 is a mechanism for transporting the print medium P. The ADF 14 is provided on the document stand 12 to be freely closed or opened. The ADF 14 takes a print medium P disposed on a tray, in accordance with the control of the main controller 19. The ADF 14 transports the print medium P with the image thereon to a location on the glass plate 31 of the document stand 12.

If the print medium P is transported by the ADF 14, the scanner unit 13 is driven to a position facing a position of the glass plate 31 to which the print medium P is positioned by the ADF 14. The scanner unit 13 acquires an image from the print medium P transported by the ADF 14, for each line by the image sensor, and thus acquires image data (original document image data) of the entirety of the print medium P transported by the ADF 14.

The paper feeding cassette 15 is a cassette for accommodating a print medium P to be printed upon. The paper feeding cassette 15 is configured so as to allow a supply of the print medium P to be loaded from the outside of the housing 11. For example, the paper feeding cassette 15 is configured so as to be allowed to be withdrawn from the housing 11.

The paper discharge tray 16 is a tray for supporting the print medium P discharged from the image forming apparatus 1.

The image forming unit 17 forms an image on a print medium P based on the control of the main controller 19. For example, the image forming unit 17 charges the drum, and forms a latent image using image data (print data) for printing, on the charged drum. The image forming unit 17 adheres a toner to the latent image formed on the drum and transfers the toner adhering to the latent image, onto the print medium P. Thus, the image forming unit 17 forms an image on the print medium P. The image forming unit 17 includes, for example, a drum 41, an exposure machine 42, a developing machine 43, a transfer belt 44, a pair of transfer rollers 45, and a pair of fixing rollers 46, as illustrated in FIG. 1.

The drum 41 is a photoconductive drum which is formed to have a cylindrical shape. The drum 41 is provided to come into contact with the transfer belt 44. The surface of the drum 41 is uniformly charged by a charging charger (not illustrated). The drum 41 is rotated at a constant speed by a driving mechanism (not illustrated).

The exposure machine 42 forms an electrostatic latent image on the charged drum 41. The exposure machine 42 irradiates the surface of the drum 41 with a laser beam from a light emitting element or the like in accordance with the print data, and thus forms an electrostatic latent image on the surface of the drum 41. The exposure machine 42 includes a light emitting unit and an optical element.

The light emitting unit has a configuration in which light emitting elements for emitting light in accordance with an electric signal (image signal) are arranged in a line. Each of the light emitting elements in the light emitting unit emits light having a wavelength which allows a latent image to be formed on the charged drum 41. The light emitted from the light emitting unit forms an image on the surface of the drum 41 by the optical element.

The developing machine 43 adheres the toner (developer) to the electrostatic latent image formed on the drum 41. Thus, the developing machine 43 forms a toner image on the surface of the drum 41.

The drum 41, the exposure machine 42, and the developing machine 43 of the image forming unit 17 are provided for each of colors of cyan, magenta, yellow, and black, for example. In this case, a plurality of the developing machines 43 hold toners of the different colors, respectively.

The transfer belt 44 is a member that receives a toner image formed on the surface of the drum 41 and causes the toner image to be transferred to a print medium P. The transfer belt 44 is moved by the rotation of the roller. The transfer belt 44 receives the toner image formed on the drum 41 at a position in contact with the drum 41, and moves the received toner image to the pair of transfer rollers 45.

The pair of transfer rollers 45 are configured to interpose the transfer belt 44 and a print medium P therebetween. The pair of transfer rollers 45 causes the toner image on the transfer belt 44 to be transferred to the print medium P.

The pair of fixing rollers 46 are configured to interpose the print medium P therebetween. The pair of fixing rollers 46 are heated by a heater (not illustrated). The pair of fixing rollers 46 press on the nipped print medium P in the heated state, and thus fixes the toner image formed on the print medium P. That is, the pair of fixing rollers 46 fix the toner image, and thus cause an image to be formed on the print medium P.

The transporting unit 18 transports a print medium P. The transporting unit 18 includes a transporting path and a sensor. The transporting path is configured of a plurality of guides and a plurality of rollers. The sensor detects a transportation position of the print medium P on the transporting path. The transporting path is a path on which a print medium P is transported. A transporting roller is rotated by a motor which operates based on the control of the main controller 19. Thus, the print medium P is transported along the transporting path. Some of the plurality of guides are rotated by a motor which operates based on the control of the main controller 19, and thus causes the transporting path for transporting a print medium P to be switched.

For example, as illustrated in FIG. 1, the transporting unit 18 includes a feeding roller 51, a fed paper transporting path 52, a discharged paper transporting path 53, and a reversal transporting path 54.

The feeding roller 51 takes a print medium P accommodated in the paper feeding cassette 15, out to the fed paper transporting path 52.

The fed paper transporting path 52 is a transporting path for transporting the print medium P which is taken out from the paper feeding cassette 15 by the feeding roller 51, to the image forming unit 17.

The discharged paper transporting path 53 is a transporting path for discharging a print medium P on which an image is formed by the image forming unit 17, from the housing 11. The print medium P discharged on the discharged paper transporting path 53 is discharged to the paper discharge tray 16.

The reversal transporting path 54 is a transporting path for supplying a print medium P to the image forming unit 17 again in a state where, for example, the front and the back, or the front and the rear of the print medium P on which an image is formed by the image forming unit 17 are reversed.

The main controller 19 controls the image forming apparatus 1. The main controller 19 includes, for example, a CPU, a ROM, a RAM, and a nonvolatile memory.

The CPU is an arithmetic element (for example, processor) that performs arithmetic processing. The CPU performs various types of processing based on data such as a program, which is stored in the ROM. The CPU functions as a control unit which can perform various operations, by executing a program stored in the ROM. The CPU inputs print data for forming an image on a print medium P, to the image forming unit 17. The CPU inputs a transporting control signal for an instruction to transport a print medium P, to the transporting unit 18.

The ROM is a nonvolatile memory which is a read only memory. The ROM stores a program and data used in the program, for example.

The RAM is a volatile memory functioning as a working memory. The RAM temporarily stores data during the processing of the CPU. The RAM temporarily stores a program executed by the CPU.

The nonvolatile memory is a storage medium (storage unit) which is capable of storing various types of information. The nonvolatile memory stores a program and data used in the program, for example. As the nonvolatile memory, for example, a solid state drive (SSD), a hard disk drive (HDD), or another storage device is provided. Instead of the nonvolatile memory, a memory IF such as a card slot into which a storage medium such as a memory card can be inserted may be provided.

The image forming apparatus 1 has states such as a ready state and a sleep state. In the ready state, an image is allowed to be formed on a print medium P. In the sleep state, waiting for an input of a predetermined operation is performed.

When the CPU is in the ready state, the power is supplied to the image forming unit 17 and the transporting unit 18. That is, when the CPU is in the ready state, the image forming unit 17 and the transporting unit 18 are maintained in an operable state. The CPU switches the state of the image forming apparatus 1 from the ready state to the sleep state in accordance with a predetermined operation, an elapsed time from when an image is finally formed, or received data.

When the CPU is in the sleep state, the supply of the power to the image forming unit 17 and the transporting unit 18 is cut off. The CPU switches the state of the image forming apparatus 1 from the sleep state to the ready state in accordance with a predetermined operation or received data.

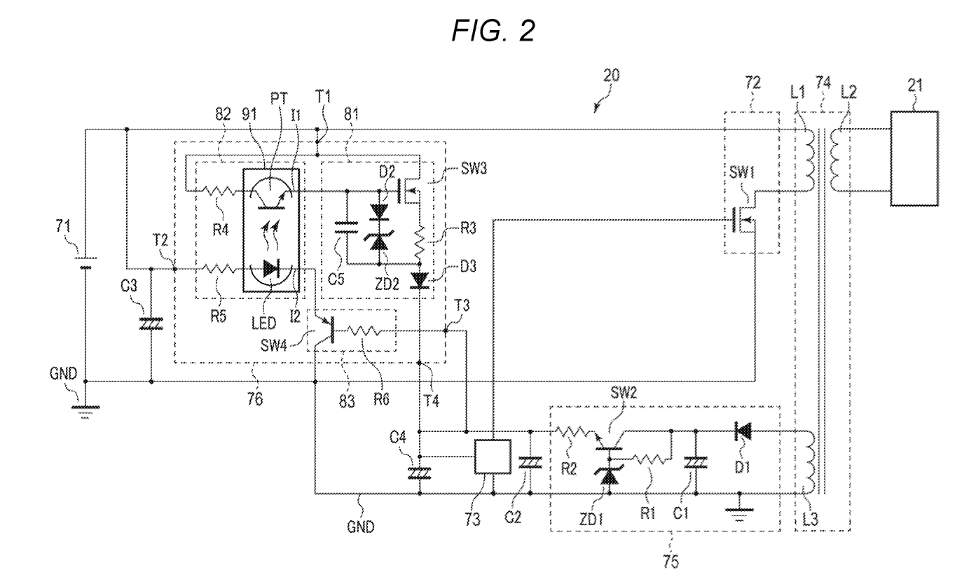

The power conversion device 20 is a power supply circuit configured to supply electric power to various components of the image forming apparatus 1. FIG. 2 is a circuit diagram illustrating a configuration of the power conversion device 20.

The power conversion device 20 includes a DC voltage source 71, an insulating DC-DC converter 72, a control circuit 73, an electric transformer 74, an auxiliary power supply circuit 75, and a startup circuit 76. The power conversion device 20 may further include a power factor improvement circuit.

The DC voltage source 71 is a circuit configured to perform full-wave rectification of AC power input from the outside of the device 20, such as a commercial power supply or the like, and to supply a DC voltage to a circuit at the subsequent stage. For example, the DC voltage source 71 is configured by a plurality of diodes, and includes a rectifying bridge configured to receive the input AC power and a capacitor connected to an output terminal of the rectifying bridge.

The insulating DC-DC converter 72 is a converter circuit configured to convert a DC voltage into a high-frequency pulse. The insulating DC-DC converter 72 is, for example, a flyback converter. The insulating DC-DC converter 72 includes a first switching element SW1 configured to perform ON and OFF operations in accordance with a control of the control circuit 73.

The first switching element SW1 is a semiconductor switch and, for example, an n-type channel FET. In the first switching element SW1, a drain terminal is connected to the DC voltage source 71 via the electric transformer 74, a source terminal is connected to a GND, and a gate terminal is connected to the control circuit 73.

The insulating DC-DC converter 72 converts a DC voltage supplied from the DC voltage source 71 into a high-frequency pulse, in a manner that the first switching element SW1 performs the ON and OFF operations in accordance with the control of the control circuit 73. The insulating DC-DC converter 72 supplies the generated high-frequency pulse to the electric transformer 74.

The insulating DC-DC converter 72 may be replaced with another converter circuit such as a half-bridge converter or a full-bridge converter.

The control circuit 73 controls the ON and OFF state of the first switching element SW1 of the insulating DC-DC converter 72. The control circuit 73 is a general PWM control IC configured to operate using DC power. The control circuit 73 inputs a pulse signal to the gate terminal of the first switching element SW1. Thus, the control circuit 73 performs switching of the first switching element SW1 between ON and OFF. For example, the first switching element SW1 is caused to turn ON (conductive) when the pulse signal has an H (high) level. The first switching element SW1 is caused to turn OFF (non-conductive) when the pulse signal has a L (low) level. The control circuit 73 performs switching of the first switching element SW1 between ON and OFF in accordance with the pulse signal, and thus generates a high-frequency pulse in the insulating DC-DC converter 72. The control circuit 73 generates a pulse signal input to the gate terminal of the first switching element SW1, based on a frequency in accordance with the control of the main controller 19 and a duty ratio between the H level and the L level. The control circuit 73 can adjust a voltage output by the power conversion device 20, by changing the duty ratio of the H level and the L level.

The electric transformer 74 supplies power from the primary side thereof to the secondary side thereof using the high-frequency pulse supplied from the insulating DC-DC converter 72. The electric transformer 74 includes a primary winding L1, a secondary winding L2, and an auxiliary winding L3.

The primary winding L1 is a transformer winding connected to the output terminal of the insulating DC-DC converter 72. One terminal of the primary winding L1 is connected to the DC voltage source 71 via the insulating DC-DC converter 72. The other terminal thereof is connected to the drain terminal of the first switching element SW1 in the insulating DC-DC converter 72. When the high-frequency pulse is supplied from the insulating DC-DC converter 72, the primary winding L1 generates a magnetic field.

The secondary winding L2 is a transformer winding which is isolated from the primary winding L1 and is connected to a load 21 to which power is supplied by the power conversion device 20. The secondary winding L2 is excited in accordance with the magnetic field generated by the primary winding L1, and thus generates power. A voltage depending on a ratio of the number of windings of the primary winding L1 and the secondary winding L2 is generated in the secondary winding L2. A capacitor (not illustrated) for smoothing power generated by the secondary winding L2 may be connected to the secondary winding L2.

The auxiliary winding L3 is a transformer connected to the auxiliary power supply circuit 75. The auxiliary winding L3 is excited in accordance with the magnetic field generated by the primary winding L1, and thus generates power. A voltage depending on a ratio of the number of windings of the primary winding L1 and the auxiliary winding L3 is generated in the auxiliary winding L3.

In the above configuration, when the first switching element SW1 is conductive or ON, a current flows in an order of the DC voltage source 71, the primary winding L1 of the electric transformer 74, the first switching element SW1, and the GND. Thus, energy is excited in the electric transformer 74. When the first switching element SW1 is conductive or On, a current is generated in the secondary winding L2 by energy excited in the electric transformer 74. Thus, power is supplied to the secondary side.

The auxiliary power supply circuit 75 supplies power to the control circuit 73 and the startup circuit 76 using the power generated in the auxiliary winding L3. The auxiliary power supply circuit 75 includes a first rectifier D1, a first capacitor C1, a first resistor R1, a second switching element SW2, a first zener diode ZD1, and a second resistor R2.

The second switching element SW2 is a semiconductor switch and, for example, an npn type transistor or an n-type MOSFET.

The first rectifier D1 is, for example, a diode. In the first rectifier D1, an anode is connected to one terminal of the auxiliary winding L3, and a cathode is connected to the first capacitor C1, the collector terminal of the second switching element SW2, and the first resistor R1. The other terminal of the auxiliary winding L3 is connected to the GND in the auxiliary power supply circuit 75.

The first capacitor C1 is connected between the anode of the first rectifier D1 and the GND.

The first resistor R1 is connected between the anode of the first rectifier D1 and the base terminal of the second switching element SW2.

In the first zener diode ZD1, the anode thereof is connected to the GND, and the cathode thereof is connected to the base terminal of the second switching element SW2.

The second resistor R2 is connected to the emitter terminal of the second switching element SW2.

In the above-described configuration, the first rectifier D1 rectifies power generated in the auxiliary winding L3 and the first capacitor C1 smooths the rectified power signal. A current flows into the base terminal of the second switching element SW2 via the first resistor R1 by a voltage which is smoothed by the first capacitor C1. Thus, the second switching element SW2 is made conductive (ON). Since the first zener diode ZD1 is connected to the base terminal of the second switching element SW2, the auxiliary power supply circuit 75 outputs a DC voltage depending on the potential of the first zener diode ZD1, via the second resistor R2.

The output terminal of the auxiliary power supply circuit 75 is connected to the control circuit 73. The second capacitor C2 is connected across the output terminal of the auxiliary power supply circuit 75 and GND in parallel with the control circuit 73.

The startup circuit 76 supplies a constant current to the control circuit 73 by using the DC voltage obtained from the AC power supply. The startup circuit 76 includes a first terminal T1, a second terminal T2, a third terminal T3, a fourth terminal T4, a constant current circuit 81, a signal isolation circuit 82, and a suspension circuit 83. The first terminal T1 is connected to the DC voltage source 71. The second terminal T2 is connected in parallel with a third capacitor C3 which is connected in series to the DC voltage source 71. The third terminal T3 is connected to the output terminal of the auxiliary power supply circuit 75. The fourth terminal T4 is connected to the parallel connection of the fourth capacitor C4 and the control circuit 73.

The constant current circuit 81 includes a third switching element SW3, a third resistor R3, a second rectifier D2, a second zener diode ZD2, a fifth capacitor C5, and a third rectifier D3.

The third switching element SW3 is a semiconductor switch and, for example, an n-type MOSFET. In the third switching element SW3, a drain terminal is connected to the first terminal T1 and a gate terminal is connected to the signal isolation circuit 82. The source terminal of the third switching element SW3 is connected to the fourth terminal T4 via a series connection of the third resistor R3 and the third rectifier D3 having the anode thereof connected to the third resistor R3.

In the second rectifier D2, the anode thereof is connected to the gate terminal of the third switching element SW3 and the cathode is connected to the cathode of the second zener diode ZD2. The anode of the second zener diode ZD2 is connected to a connection point of the third resistor R3 and the third rectifier D3.

In the fifth capacitor C5, one terminal is connected to the gate terminal of the third switching element SW3 and the other terminal is connected to the connection point of the third resistor R3 and the third rectifier D3. That is, the fifth capacitor C5 is connected in parallel with a series connection of the second rectifier D2 and the second zener diode ZD2.

The signal isolation circuit 82 includes an isolator 91, a fourth resistor R4, and a fifth resistor R5.

The isolator 91 is a circuit in which a first current path I1 thereof connected to the third switching element SW3 and the second current path I2 isolated from the first current path I1 are provided, and the first current path I1 is conductive when a current flows in the second current path I2. The isolator 91 is configured, for example, by a photocoupler.

When the isolator 91 is configured by a photocoupler, the isolator 91 includes an emitter and a collector which are terminals of the first current path I1, an anode and a cathode which are terminals of the second current path I2, a light emitting diode LED, a photo-transistor PT, and the like. The collector of the isolator 91 corresponds to the collector terminal of the photo-transistor PT and is connected to the gate terminal of the third switching element SW3. The emitter of the isolator 91 corresponds to the emitter terminal of the photo-transistor PT and is connected to the first terminal T1 via the fourth resistor R4. The anode of the isolator 91 corresponds to the anode terminal of the light emitting diode LED and is connected to the second terminal via the fifth resistor R5. The cathode of the isolator 91 corresponds to the cathode terminal of the light emitting diode LED and is connected to the suspension circuit 83.

When a current flows in the second current path I2, the light emitting diode LED emits light and causes the light to be incident on the photo-transistor PT.

When light is incident from the light emitting diode LED, the path between the emitter and the collector of the photo-transistor PT, that is, the first current path I1 is conductive.

The suspension circuit 83 includes a fourth switching element SW4 and a sixth resistor R6.

The fourth switching element SW4 is a semiconductor switch and, for example, a pnp type transistor or a p-type MOSFET. The emitter terminal of the fourth switching element SW4 is connected to the cathode of the isolator 91 in the signal isolation circuit 82. The base terminal of the fourth switching element SW4 is connected to the third terminal via the sixth resistor R6. The collector terminal of the fourth switching element SW4 is connected to the GND.

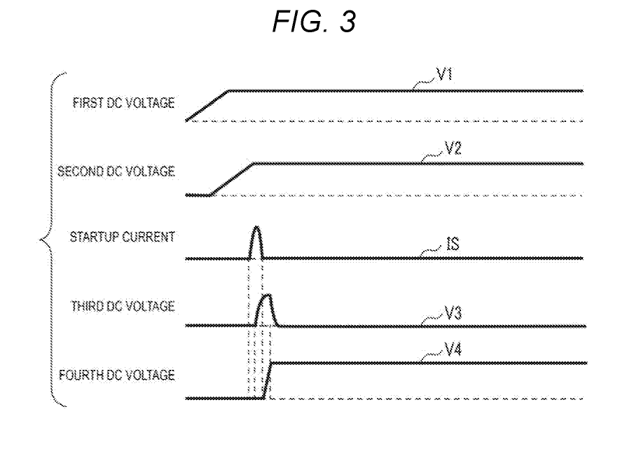

Next, an operation of the power conversion device 20 will be described with reference to FIG. 3. FIG. 3 is a diagram illustrating changes of a voltage and a current in the power conversion device 20. A vertical axis in FIG. 3 indicates a voltage value or a current value, and a horizontal axis indicates a time.

According to the above-described configuration, a first DC voltage V1 is input to the first terminal T1 of the startup circuit 76 from the DC voltage source 71, and a second DC voltage V2 is input to the second terminal T2 of the startup circuit 76.

The fourth switching element SW4 in the suspension circuit 83 is a normally on switch. Thus, a current (startup current) IS is generated by the second DC voltage V2. The startup current IS flows to the GND through the second terminal T2, the fifth resistor R5, a path between the anode and the cathode of the isolator 91, and a path between the emitter and the collector of the fourth switching element SW4. As a result, the light emitting diode LED in the isolator 91 emits light by the flow of the startup current IS. The emitted light is incident on the photo-transistor PT, and thus a path between the emitter and the collector of the isolator 91 is in the conductive state.

If the path between the emitter and the collector of the isolator 91 is in the conductive state, a current flows into the fifth capacitor C5 via the first terminal T1, the fourth resistor R4, and the path between the emitter and the collector of the isolator 91. Accordingly, the fifth capacitor C5 is charged. If the potential of the fifth capacitor C5 is increased up to the zener potential of the second zener diode ZD2, the path between the drain and source of the third switching element SW3 enters into the conductive state.

If the third switching element SW3 is conductive, a third DC voltage V3 is output from the fourth terminal T4 via the third switching element SW3, the third resistor R3, and the third rectifier D3 using the first DC voltage V1 input to the first terminal T1. A current for starting up the control circuit 73 is supplied to the control circuit 73 by the third DC voltage V3. Accordingly, the control circuit 73 is started up and thus starts the control of the first switching element SW1 in the insulating DC-DC converter 72. As a result, the electric transformer 74 is excited, and thus power is supplied to the secondary winding L2 and the auxiliary winding L3.

If power is supplied to the auxiliary winding L3, a path between the collector and the emitter of the second switching element SW2 in the auxiliary power supply circuit 75 becomes conductive. Thus, power is supplied to the control circuit 73 from the auxiliary power supply circuit 75.

As described above, since the gate terminal of the third switching element SW3 is connected to the collector of the isolator 91 in the startup circuit 76, it is possible to maintain the third switching element SW3 in the non-conductive state without an occurrence of a situation in which a current path is formed. According to this configuration, power is not consumed during a period when the startup circuit 76 is suspended, that is, during a period when the third switching element SW3 is in the non-conductive state. As a result, it is possible to reduce losses occurring when the operation of the startup circuit 76 is suspended.

In addition, a fourth DC voltage V4 is supplied to the suspension circuit 83 from the auxiliary power supply circuit 75 via the third terminal T3 connected to the output terminal of the auxiliary power supply circuit 75. The fourth DC voltage V4 input to the suspension circuit 83 is applied to the base terminal of the fourth switching element SW4 via the sixth resistor R6. A path of the emitter and the collector of the fourth switching element SW4 enters into the non-conductive state by application of the fourth DC voltage V4. As a result, the startup current IS which flows to the GND through the second terminal T2, the fifth resistor R5, the path between the anode and the cathode of the isolator 91, and the path of the emitter and the collector of the fourth switching element SW4 in the startup circuit 76 in the startup mode is now not provided. Since the startup current IS does not flow in the light emitting diode LED of the isolator 91, the path between the emitter and the collector of the isolator 91 is in the non-conductive state. As a result, the path between the drain and the source of the third switching element SW3 is in the non-conductive state, and the operation of the startup circuit 76 is suspended.

As described above, when power is generated in the auxiliary winding L3, the path between the emitter and the collector of the isolator 91 is in the non-conductive state, and the third switching element SW3 of the constant current circuit 81 configured to supply a constant current to the control circuit 73 is in the non-conductive state. Thus, the operation of the startup circuit 76 is suspended. That is, the startup circuit 76 has a configuration of suspending its operation after the control circuit 73 is started up. Accordingly, it is possible to prevent the startup circuit 76 from continuously consuming power during the operation of the power conversion device 20.

In particular, the power conversion device 20 can suppress loss of power during a standby state, and can quickly start up the control circuit 73. Therefore, the power conversion device 20 is useful in, for example, a MFP in which a long waiting time is provided and it is desired to reduce a time until the device is started. Even though the power supply is only one power system, the power conversion device 20 can be applied.

In the embodiment, a case where the isolator 91 is a photocoupler is described. However, it is not limited to this configuration. The isolator 91 may be configured by a relay switch.

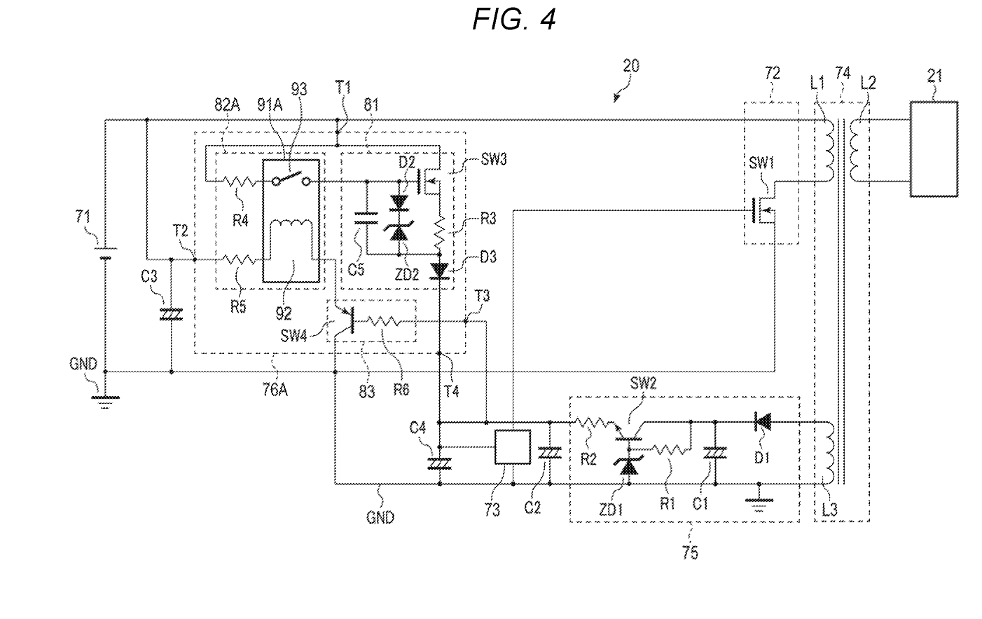

FIG. 4 is a diagram illustrating an startup circuit 76A which includes an isolator 91A configured using a relay switch.

The startup circuit 76A supplies a constant current to the control circuit 73 by using the DC voltage obtained from the AC power supply. The startup circuit 76A includes a first terminal T1, a second terminal T2, a third terminal T3, a fourth terminal T4, a constant current circuit 81, a signal isolation circuit 82A, and a suspension circuit 83.

The signal isolation circuit 82A includes an isolator 91A, a fourth resistor R4, and a fifth resistor.

The isolator 91A is a circuit in which a first current path I1 connected to the third switching element SW3 and a second current path I2 isolated from the first current path I1 are provided, and the first current path I1 becomes conductive when a current flows in the second current path I2. The isolator 91A is configured by a relay switch.

When the isolator 91A is configured by a relay switch, the isolator 91A includes a coil 92 and a contact mechanism (switch) 93 having a movable contact point and a fixed contact point.

The coil 92 generates a magnetic field depending on the current flowing therethrough. The coil 92 is connected to the second current path I2. For example, in the coil 92, one terminal is connected to the second terminal T2 via the fifth resistor R5, and the other terminal is connected to the emitter of the fourth switching element SW4 in the suspension circuit 83.

The switch 93 performs switching between the conductive state and the non-conductive state, in accordance with the magnetic field generated by the coil 92. The switch 93 is connected to the first current path I1. For example, in the switch 93, the movable contact point is connected to the first terminal T1 via the fourth resistor R4, and the fixed contact point is connected to the gate of the third switching element SW3 in the constant current circuit 81.

Also with the above-described configuration, the startup current IS which flows to the GND through the second terminal T2, the fifth resistor R5, the winding 92 of the isolator 91, and the path between the emitter and the collector of the fourth switching element SW4 is generated by the second DC voltage V2 input to the second terminal T2. As a result, the coil 92 of the isolator 91 is excited and generates a magnetic field. The switch 93 of the isolator 91 causes the first current path I1 of the isolator 91 to be in the conductive state, in a manner that the movable contact point is driven by the magnetic field generated in the coil 92 and the movable contact point comes into contact with the fixed contact point. Thus, the path between the drain and the source of the third switching element SW3 is in the conductive state. As described above, the isolator 91A can exhibit an effect similar to that of the isolator 91.

In the embodiment, descriptions are made on the assumption that the startup circuit 76 has a configuration in which a portion of the voltage supplied from the DC voltage source 71 is input to the first terminal T1 and the second terminal T2. However, the startup circuit 76 is not limited to this configuration. The startup circuit 76 may have a configuration in which the second terminal T2 receives a supply of a voltage from another power supply not from the DC voltage source 71.

For example, the power conversion device 20 may have a configuration in which a plurality of power systems configured by an insulating DC-DC converter, an electric transformer, and a control circuit are provided, and DC power is received from another power system and is supplies to the second terminal T2 of the startup circuit 76.

For example, a power conversion device used in a MFP further includes a power system for operating the main controller 19. In the power system for operating the main controller 19, the function to start up the control circuit is provided in many cases. Thus, the startup circuit is not required. In this manner, the second terminal T2 of the startup circuit 76 receives a supply of DC power from another power system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

1. A power conversion device comprising:
a power supply;
a transformer comprising a primary winding, a first secondary winding and a second secondary winding;
a converter connected to the primary winding of the transformer;
a control circuit connected to the converter; and
a startup circuit comprising:
a first switching element configured to switch between an ON state wherein current may pass therethrough, and an OFF state wherein current is prevented from passing therethrough,
a constant current circuit configured to supply power of a predetermined voltage to the control circuit when the first switching element is in the ON state, and
an isolation circuit comprising a first current path connected to a control terminal of the first switching element and including a phototransistor or a relay switch, and a second current path isolated from the first current path and including a selectable connection to ground,
wherein the first switching element is switched to the ON state as a result of current flowing through the photo transistor or the relay switch in the first current path when current flows in the second current path.

2. The power conversion device of claim 1, wherein the control circuit is configured to output a control signal to the converter to cause the converter to intermittently switch between an ON and OFF state to intermittently open a current path between the output of the power supply and ground, said current path including the primary winding of the transformer.

3. The power conversion device of claim 2, further comprising an auxiliary circuit connected between the second secondary winding of the transformer and the control circuit.

4. The power conversion device of claim 3, further comprising a suspension element connected between the second current path and ground.

5. The power conversion device of claim 4, wherein the suspension element is further connected to the auxiliary circuit, and, when current flows in the second secondary winding of the transformer, current from the auxiliary circuit powers the control circuit and provides a current signal to the suspension element, causing the suspension element to suspend the connection of the second current path to ground.

6. The power conversion device of claim 2, wherein the converter comprises an n-type channel MOSFET, and the control signal from the control circuit is connected to the gate thereof.

7. The power conversion device of claim 1, wherein
the second circuit path includes a light output device which outputs light when current flows through the second circuit path, and
the first current path includes the phototransistor, the phototransistor switching the first current path to the ON state when light is received thereby from the light output device.

8. The power conversion device of claim 1, wherein
the second circuit path includes a coil, and
the first current path includes the relay switch, the relay switch operable in response to a magnetic field arising when current is flowing through the coil in the second current path.

9. The power conversion device of claim 1, wherein the constant current circuit comprises:
a capacitor; and
a first rectifier and a Zener diode connected in series, the capacitor connected in parallel with the rectifier and Zener diode connected in series.

10. An image forming apparatus comprising:
a power conversion device which includes a converter configured to perform switching of power supplied to an electric transformer from a power source, a control circuit configured to control the switching of the converter, and a startup circuit configured to start up the control circuit, wherein the transformer comprises a primary winding, a first secondary winding and a second secondary winding; and
an image forming unit configured to receive the supply of power from the power conversion device and to form an image on a print medium,
wherein the startup circuit includes:
a first switching element configured to switch between an ON state wherein current may pass therethrough, and an OFF state wherein current is prevented from passing therethrough,
a constant current circuit configured to supply power of a predetermined voltage to the control circuit when the first switching element is in the ON state, and
an isolation circuit comprising a first current path connected to a control terminal of the first switching element and including a phototransistor or a relay switch, and a second current path isolated from the first current path and including a selectable connection to ground, and
wherein the first switching element is switched to the ON state as a result of current flowing through the photo transistor or the relay switch in the first current path when current flows in the second current path.

11. The image forming apparatus of claim 10, wherein the control circuit is configured to output a control signal to the converter to cause the converter to intermittently switch between an on and off state to intermittently open a current path between the power source and ground, which path includes the primary winding of the transformer.

12. The image forming apparatus of claim 11, further comprising an auxiliary circuit connected between the second secondary winding of the transformer and the control circuit.

13. The image forming apparatus of claim 12, further comprising a suspension element connected between the second current path and ground.

14. The image forming apparatus of claim 13, wherein the suspension element is further connected to the auxiliary circuit, wherein, when current flows in the second secondary winding of the transformer, current from the auxiliary circuit powers the control circuit and provides a current signal to the suspension element, causing the suspension element to suspend the connection of the second current path to ground.

15. The image forming apparatus of claim 11, wherein the converter comprises an n-type channel MOSFET, and the control signal from the control circuit is connected to the gate thereof.

16. The image forming apparatus of claim 10, wherein
the second circuit path includes a light output device which outputs light when current flows through the second circuit path, and
the first current path includes the phototransistor, the phototransistor switching the first current path to the ON state when light is received thereby from the light output device.

17. The image forming apparatus of claim 10, wherein
the second circuit path includes a coil, and
the first current path includes the relay switch, the relay switch operable in response to a magnetic field arising when current is flowing through the coil in the second current path.

18. The image forming apparatus of claim 1, wherein the constant current circuit comprises:
a capacitor; and
a first rectifier and a Zener diode connected in series, the capacitor connected in parallel with the rectifier and Zener diode connected in series.

19. A power conversion device connected to a power source and a load, comprising:
a first switching device configured to selectively allow power from the power source to communicate with the load in a first state thereof, and not allow power from the power source to communicate with the load in a second state thereof;
a control circuit connected to the first switching device to communicate therewith to select the first state or the second state;
a startup circuit interposed between the power source and the control circuit, the startup circuit comprising an isolation circuit and a current source circuit, the isolation circuit including a first current path and a second current path that includes a phototransistor or a relay switch, current flowing through the phototransistor or the relay switch causing current flow in the first current path; and
an auxiliary circuit interposed between the power source and the control circuit,
wherein the startup circuit is configured to supply a current to the control circuit as a result of the current flow through the first current path when the auxiliary circuit is not supplying current to the control circuit, and, to prevent current flow therethrough when not supplying current to the control circuit.

20. The power conversion device of claim 19, further comprising:
a switching element interposed between the connection of the startup circuit to ground,
wherein, when the auxiliary circuit is supplying power to the control circuit, the switching element opens the connection of the startup circuit to ground.
